(19) United States
(12) Patent Application Publication
(10) Pub. No.: US 2008/0247746 A1
(43) Pub. Date: Oct. 9, 2008

(54) Tripod Mounting, Stand, or Support Attachment, Accessory, or Mechanism for Cameras and Similar Devices or Objects

(76) Inventors: David Law, Seattle, WA (US); Graeme Esarey, Seattle, WA (US)

Correspondence Address: MAXVALUEIP CONSULTING, 11204 ALBERMYRTLE ROAD, POTOMAC, MD, 20854, US

(21) Appl. No.: 11/772,222

(22) Filed: Jun. 30, 2007

Related U.S. Application Data
(63) Continuation-in-part of application No. 11/696,740, filed on Apr. 5, 2007.

(51) Int. Cl. G03B 17/56

(52) U.S. Cl. 396/419; 248/346.01; 248/346.2

(57) ABSTRACT

Most cameras have a tripod mounting hole in the bottom with a standard screw thread. All current tripods mount use a threaded fastener that screws into this hole and tightens the camera to a tripod or other auxiliary devices. Often, the tripod will mount a small intermediary part that can remain with the camera, but which allows the camera to be quickly removed from the tripod. This disclosure obviates the need for the intermediary part. Here are some of the main features and embodiments: “Expanding Rubber Bung”: A flexible elastomeric part or other material, that when tightened, expands in girth. “Pivoting metal Christmas tree”: Similar to the above concept, except that a hard material pivots out, to clamp the sides of the hole, once it has been easily inserted in its collapsed state. The following are some of the applications and examples of the current disclosure: cameras, video recorders, civil engineering equipment for leveling measurement or surveying, laser equipment for tracking, leveling calibration, or marking, optical equipment, astronomical equipment, telescopes, binoculars, lab equipment, or calibration equipment are some examples of tripod usage or similar setups, e.g. setups with more legs, different shapes, stands, supports, or foldable/mobile setups. Many other variations and extensions are also discussed in the specification and figures.

### RELATED APPLICATIONS

This application is related to the following co-pending applications, with some common inventors, and same exact assignee: (The teaching of all the applications below are incorporated herein by reference.)
U.S. application Ser. No.: 11/695,625, filed Apr. 3, 2007.
Also: CIP of the following case: (Tripod case): U.S. application Ser. No.: 11/696,740, filed Apr. 5, 2007.
U.S. application Ser. No.: 11/695,624, filed Apr. 3, 2007.

### BACKGROUND

The cameras, video recorders, civil engineering equipment for leveling measurement or surveying, laser equipment for tracking, leveling calibration, or marking, optical equipment, astronomical equipment, telescopes, binoculars, lab equipment, or calibration equipment are some examples of tripod usage or similar setups, e.g. setups with more legs, different shapes, stands, supports, or foldable/mobile setups.

The invention here can apply to all of the above, but for the sake of simplicity, we only concentrate on tripods and cameras in our examples. However, the teaching is the same for all the applications.

The invention here, for example, deals with a quick attach and release feature and mechanism for the tripods, stand, support, or legs.

Some of the related prior art are listed here:
Davis, U.S. Pat. No. 6,991,384, teaches a camera tripod rotating head that is used for taking 360 degree photographic images, with a camera mounted on a tripod. The rotating head consists of an adapter base that is configured to mate and attach to the camera tripod, and includes a one way roller clutch mounted within the adapter base, and a shoulder bolt that is positioned through both the base and the clutch. A rotating beam is attached to the adapter base with the shoulder bolt, allowing the beam to revolve around the base a full 360 degrees, in one direction only. Detents are position within the adapter base relative beam, allowing the beam to be rotated and stopped at an equidistant predetermined location, preferably sixteen, until manually urged to the next location. An adjustable camera mounting bracket, configured to mate with the camera, is manually attached to the rotating beam, permitting the rotating head, with a camera attached, to sweep in a one-way arc of rotation, stopping by the detents at each predetermined position.
Brotz, U.S. Pat. No. 6,209,830, teaches an apparatus for mounting a camera on a tripod platform, and the camera having a pear shaped ball, attached to the camera bottom, and the pear shaped ball placed into a cradle cup, attached to the platform of a tripod, which makes for a rapid mounting or removal of the camera from the mounting, without the necessity of unscrewing any of the mounting.
Mori, et al., U.S. Pat. No. 6,007,259, teaches a monopod body being constructed such that inside pipes having smaller diameters and sequentially are being extensively inserted into an outside pipe, in a telescopic fashion, and a bracket, to which a panhead is attached, is fitted into the upper end of the outside pipe. Two auxiliary legs, whose lengths are substantially equal to the shortest length of the monopod body, when the monopod body is contracted most, are pivotally attached to the bracket, so that the two auxiliary legs can be rotated with an inclination of a predetermined angle. Therefore, the monopod for supporting a camera or the like can be served also as a tripod.

However, none of the above teaches the features of the current application and invention, as described below.

### SUMMARY

Almost all cameras have a tripod mounting hole in the bottom with a standard screw thread. All current tripods use a threaded fastener that screws into this hole and tightens the camera to a tripod or other auxiliary devices. Often, the tripod will mount a small intermediary part that can remain with the camera, but which allows the camera to be quickly removed from the tripod or auxiliary device. This invention obviates the need for the intermediary part. Rather than screwing on the tripod, an auxiliary piece has a feature that would attach directly and quickly to the tripod mount hole. Here are some of the main features and embodiments:

Expanding Rubber Bung: A flexible elastomeric part or other material, that when tightened, expands in girth. That is, it can slip into the mounting hole and then be rapidly expanded with a lever, or similar object, to expand and clamp on the side walls of the tripod mount hole. The basic version of this has a rubber plug, which in its natural states, is smaller than the hole. It has a hole in the center, through which a rigid member passes, and has a large head on the side of the plug, inside the hole. Pulling that rigid member back and compressing the length of the plug causes it to expand to the side, and clamp the tripod mount hole sides, fixing the part to the camera.

Pivoting metal Christmas tree: Similar to the above concept, except that a hard material pivots out, to clamp the sides of the hole, once it has been easily inserted in its collapsed state.

To fit this for any size thread and screw, for different camera models, or other electronic and non-electronic equipment and device, employing a tripod or a stand, with different number of legs, and various form and shape, one has to adjust on the size or diameter of thread or screw, to fit them together perfectly. One way to fill the gap, and the difference between a smaller screw (diameter D1) and a larger thread (opening, diameter D2), is to have some small short hollow cylinders made up in different sizes or shapes with these two parameters in mind:
1. The outer diameter of the cylinder is threaded to fit exactly the thread size and diameter of the larger thread, diameter D2.
2. The inner diameter of the cylinder, or the diameter of the hollow section in the middle, which is also threaded to fit the smaller screw, is measured a distance of D1, in diameter.

Having many cylinders made, for various values of D1 and D2, pairs of (D1, D2), one can almost fit any screw to any opening thread, bigger than screw, in diameter, using these adaptors. They can be made up using plastic, metal, rubber, or glass, for example.

These screw/thread adaptors are used to customize for any model or size of the camera.

In one embodiment, we have a fast attach-and-release assembly. The threaded fastener on the bottom is inherently an attach-and-release assembly. It just can be cumbersome and often requires a tool to fully tighten or release. In our invention, it obviates the need for intermediary quick release plate, and to allow the user to attach things to the camera, without requiring a tool, which is very advantageous for the mass market.

The goal is to use a non-threaded way to attach to the existing threaded hole. That is, using the threaded sides as a gripping surface, rather than a threading surface. This allows the camera to be placed directly on the mounting part (and a button pressed/lever pulled, etc.) to affix the camera to the mount.

### BRIEF DESCRIPTION OF THE DRAWINGS

FIG. 1 shows a “quick-attach-and-release” configuration.

FIG. 2 shows a typical tripod mount hole.

FIG. 3 shows the pump, for air (or other fluids, powder, gel, dust, sand, gas, liquid, pressurized gas, hot gas, foam, bubble material, or air bubbles), with an air bladder and one-way valves, along with the pressure-relief for safety, to pump up the object inside, or expand the wings or surfaces inside, to inflate or fill up, to secure the camera, connected to the tripod, or any other stand or leg(s).

### DETAILED DESCRIPTION OF THE PREFERRED EMBODIMENTS

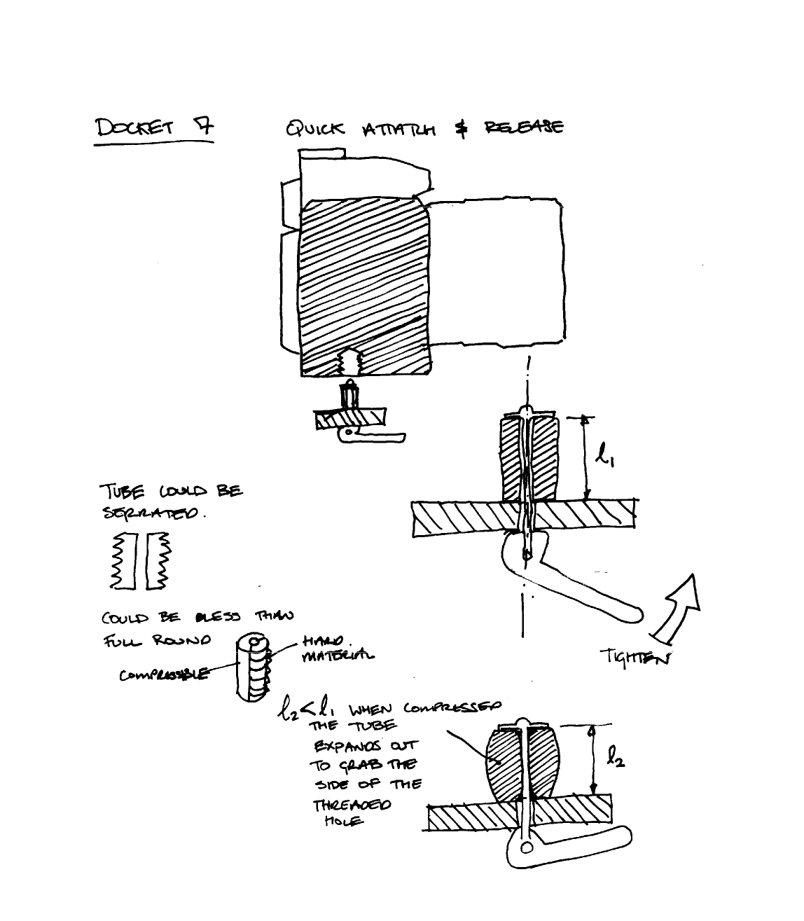

FIG. 1 shows a “quick-attach-and-release” configuration. In one embodiment, the screwed tip can go into a threaded hole on the bottom of the device. In one embodiment, it acts similar to wine-stopper setup, in which it bulges out and grabs the inside of the bottle.

In prior art, a secondary part at the bottom of the case, or base plate, which is about 0.25-0.5 inch thickness, is used to engage the tripod. However, here, in one embodiment, we eliminate the use of the extra part, or the base plate, in favor of the direct engagement with the tripod, as shown in the figures, to still have the advantages of fast and easy connection and engagement, and clipping to the tripod directly.

In one embodiment, there is a mechanism on top of tripod, to use a handle to tighten the assembly in place, in a curved motion of the handle, around one point or hinge, to fix the length as L1, as shown in the FIG. 1, removing the need for the use of the 2^{nd} base plate.

In one embodiment, the tube can be serrated, to grab better. In one embodiment, it can be less-than-full-round. In one embodiment, it is made of rigid and hard material. In one embodiment, it is made of soft or spring-like material, to be compressible and adjustable, in terms of threads. In one embodiment, it is a combination of the hard and soft material, to adjust for the size of the threads.

In one embodiment, when compressed, the tube expands out to grab the sides of the threaded hole, from inside, bulging out, producing extra friction, to hold better, as denoted in the FIG. 1, with L2 as the new length, in which we have L2 smaller than L1, or (L2<L1). That is, in the insert position, we insert and clamp, to fix the position.

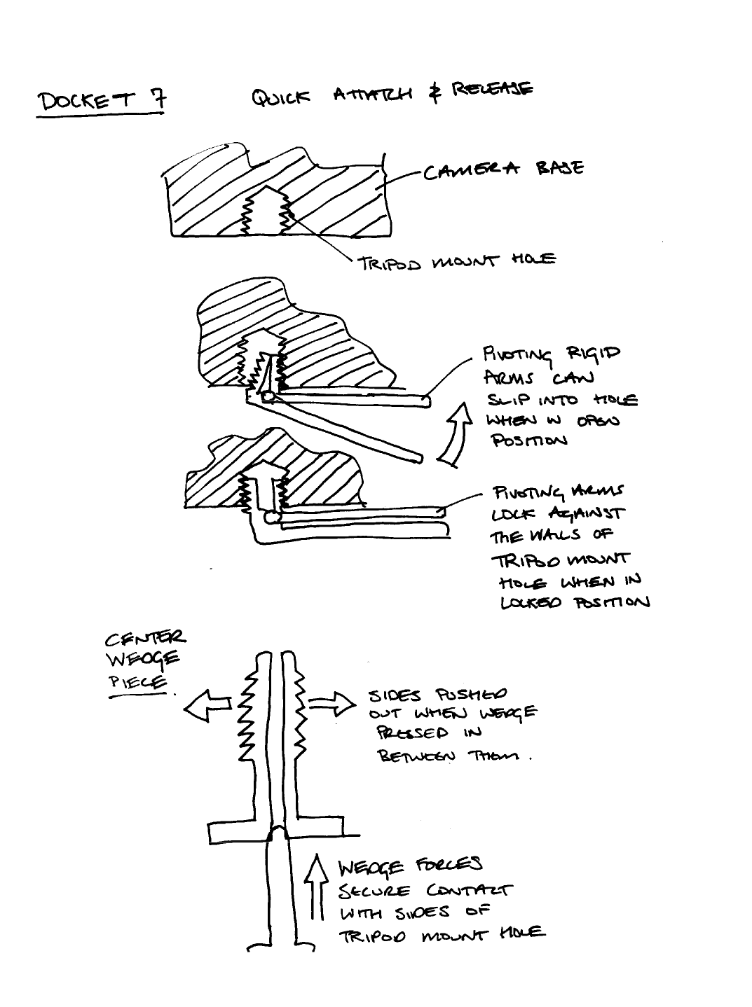

FIG. 2 shows a typical tripod mount hole. In one embodiment, the pivoting rigid arms can slip into the hole, in the open position. In the locked position, the pivoting arms lock against the walls of the tripod mount hole, making it set at the position, locked and secure.

In one embodiment, we have a center wedge piece, and the sides are pushed outward radially, when the wedge is pressed in between them, as the wedge is rotated in or pushed in, as in a screw or as in a nail. Thus, wedge forces secure contact with sides of tripod mount hole. The extra friction secures the assembly in place.

In one embodiment, as the wedge or screw is pushed in or screwed in, the wings inside the object around the tip of the wedge will open up, in the opposite direction, such that it would be almost impossible to pull/yank the wedge out, by force, backward, out of the object. (i.e. the wings have to break up, or the object must be severely damaged, prior to inadvertent removal.)

In one embodiment, the bulging or expansion is done inside the object, using a balloon with pumped air or fluid, or a inflatable object with multiple wings, to expand inside the object, and set the connection secured and tight. (This is done around the wedge assembly, or instead of wedge assembly.)

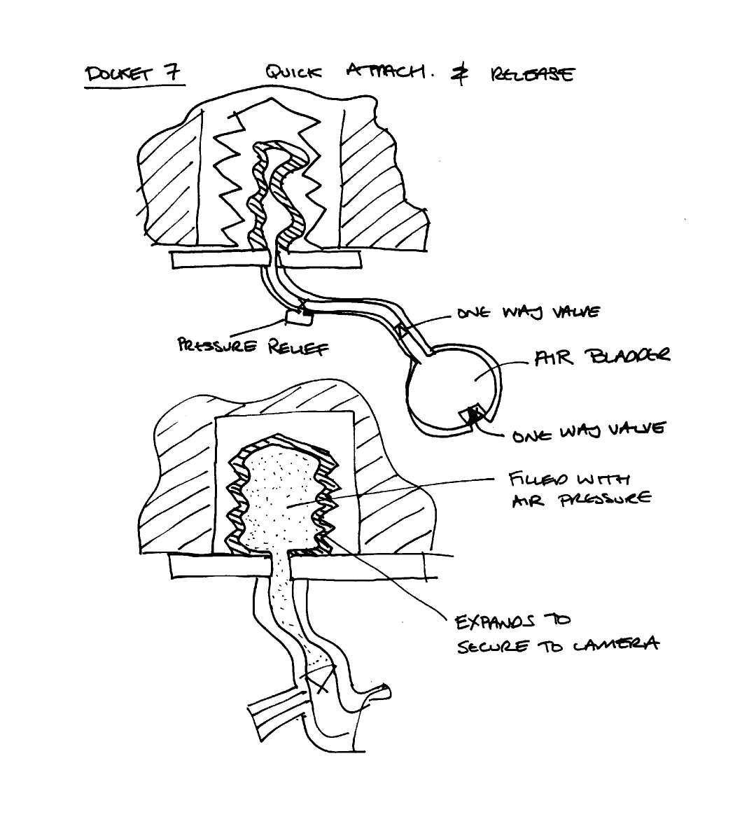

FIG. 3 shows the pump, for air (or other fluids, powder, gel, dust, sand, gas, liquid, pressurized gas, hot gas, foam, bubble material, or air bubbles), with an air bladder and one-way valves, along with the pressure-relief for safety, to pump up the object inside, or expand the wings or surfaces inside, to inflate or fill up, to secure the camera, connected to the tripod, or any other stand or leg(s). The inflatable object can have many layers, and can be rigid, semi-rigid, or flexible structure. In one embodiment, it has small rigid surface connected together by flexible thin short chain or band, such as or similar to a fishing net, mesh, or window screen, to conform to any shape, from inside, when gets filled up.

In one embodiment, the assembly is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, or composite material.

In one embodiment, the assembly includes (in, attached to, or on it) one or more of the following items: a picture frame, clock, notebook, calculator, solar cell array, battery, pen holder, pen, pencil, magnetic plate, magnetic decoration, light, LED, LCD, display, small TV, small radio, thermometer, pressure gauge, biometric sensor, thumb/fingerprint recognition module, combination lock, lock, Velcro, hook-and-loop, password entry input, small keyboard, input device, pointing device, speaker, microphone, small telephone set, keychain ring, hook (for hanging the unit), small video game, music player, downloading unit (from Internet or satellite), wireless unit, communication unit, antenna, small computer, small web browser, recorder, or any other electronic or mechanical device, apparatus, system, toy, decoration, or equipment.

Inflatable Part, as an Embodiment, to Fit (Almost) any Size Camera In one embodiment, the inflatable part comprises multiple layers. In one embodiment, it is inflatable. In one embodiment, the it is inflated using one or more of the following, or combination or mixture of the following: gas, liquid, solid, dust, gel-type, liquidated-solid, pressurized fluid, water-absorbent sponge, sponge-type material, or any expandable solid, liquid, fluid, chemical, gas, or material, caused by chemical reaction, heat, temperature variation, catalyst, chain reaction, exceeding critical mass, seed material, mixing, or pressure.

In one embodiment, the size or shape of it is adjusted based on the size, model, or type of the camera. In one embodiment, the inflation is adjusted based on the size, model, or type of the camera. In one embodiment, the size or shape of it is adjusted by one or more of the following, or a combination of the following: a user, a computer, feedback from one or more sensors, feedback module, pressure gauges at different points, data about the model number or type of said camera, data about the dimensions or weight of said camera, fuzzy logic system, a training module, or a neural network module. In one embodiment, it has multiple parts or chambers, each of which can be optimized, or inflated separately, or in concert, with respect to each other.

In one embodiment, a database holds all the information about specific cameras, to inflate the components or parts accordingly, to fit the camera. The more individual chamber or parts we have (smaller chambers), the easier one can make it fit to the shape of a specific camera. The chambers can be connected together, or can be individually inflated, independent of each other. Once the chambers are filled, the pump can be disconnected, and the chambers are sealed, against leakage. The pumps can be electrically, battery, chemically, or manually (hand or foot) operated.

This embodiment is useful for semi-custom-made or generic setup, to act or behave as a custom-made (fit perfectly with the camera).

### Angle Adjustment

There are three axes around which the camera can be adjusted, Pitch, Roll and Yaw. Generally, in the 3-dimensional space, we need 3 orthogonal or independent parameters/axes/coordinates to define and adjust for the position.

Tripod Variations, including Extra (More than 3) Legs for the Stand

The attachment device or connection device used on the tripod (if any), is (or uses) one or more of the following devices, methods, or items (or can be used for the adjustment mechanism on the tripod): chain, hook, Velcro, hook-and-loop, belt, adjustable belt, cable, string, tether, tie, binding means, magnet, screw, nut, nail, glue, temporary glue, knot, friction-based connector, connection means, elastic band, two extremely smooth surfaces, by electrostatic force or means, or by electromagnetic force or means.

In one embodiment, the tripod is made of pivoting legs, hinged legs, flexible legs, rigid legs, goose-neck legs, segmented legs, snake-shaped flexible legs, telescopic legs (sliding mechanism or screwing-in mechanism) (with cylindrical shape, square shape, or plate shape/cross section), foldable legs (with one or multiple folds or hinges per leg), hydraulic legs, mechanically-raising-legs, inflatable legs, balloon-type legs, tube-type legs, lifting legs with a mechanism similar to helicopter (lifting and staying/stabilizing at a position in space/in mid-air, using the motors or engines attached to the assembly), legs made of series of small beads (with a string, rubber, or elastic rope going through the hollow beads) (to hold a solid shape for the whole leg, once the string or rubber is pulled), flat legs, cylindrical legs, legs with the suction cups at the end/bottom of the legs (to attach to/grab a smooth surface), curved legs, S-shaped legs, T-shaped legs, plate-shaped legs, sliding-plate-shaped legs, or any conventional legs or supports.

In one embodiment, the 90-degree swivel of one of the legs allows the support of a much bigger lens (and more stability). The legs can be 4 or more, defining only one plane on the surface (for the stability on a plain flat surface), or defining more than one planes for different set of legs (for stability on steps or ladders, for stability on an inclined or sloped surface (such as a roof or sloped street), or for stability on a curved surface). Note that 3 points in space define a unique geometrical flat surface.

In one embodiment, the legs can be in pairs (or multiple legs in a branch), or comprising small legs (or flexible small legs, for hugging an uneven surface, for a better stability). For better stability, the legs are connected horizontally by a chain, rod, or string, in a mid-section. The legs can be adjusted independently. (Note that adjustable screw determines how far the tilt can go.)

In one embodiment, the tripod can be attached to the camera permanently, or attached temporarily, by the user's choice. The adjustment assembly and the attachments (normally under the camera) can be positioned in the other sides of the camera, as well. In addition, in general, they do not have to be symmetrical, with respect to the camera. In one embodiment, the camera and its assembly can be rotating by a motor or by the user.

The camera can be positioned or attached under the top of the tripod, inside the space of pyramid defined by the 3 or more legs of the tripod.

Any other variation of the above teaching is also meant to be protected by the current patent.

1. An attach-and-release assembly or mounting device for a tripod or similarly attached device for a camera, video recorder, or similar object,
wherein said attach-and-release assembly or mounting device is engaged or connected to said camera, video recorder, or similar object, directly,
wherein said attach-and-release assembly or mounting device connects said camera, video recorder, or similar object to said tripod or similarly attached device, and
wherein said attach-and-release assembly or mounting device has a mechanism to secure or hold said camera, video recorder, or similar object with respect to said tripod or similarly attached device.

2. An attach-and-release assembly or mounting device, as recited in claim 1, wherein said attach-and-release assembly or mounting device comprises a handle,
wherein said handle is used to tighten the position of said attach-and-release assembly or mounting device with respect to said camera, video recorder, or similar object.

3. An attach-and-release assembly or mounting device, as recited in claim 1, wherein said attach-and-release assembly or mounting device comprises a tube or rod,
wherein said tube or rod is used to tighten the position of said attach-and-release assembly or mounting device with respect to said camera, video recorder, or similar object.

4. An attach-and-release assembly or mounting device, as recited in claim 1, wherein said attach-and-release assembly or mounting device comprises a tube or rod,
wherein said tube or rod is compressed,
wherein said tube or rod is bulged, and
wherein said tube or rod tightens the position of said attach-and-release assembly or mounting device with respect to said camera, video recorder, or similar object.

5. An attach-and-release assembly or mounting device, as recited in claim 1, wherein said attach-and-release assembly or mounting device comprises one or more adaptors to fit in different screw sizes with respect to different thread sizes.

6. An attach-and-release assembly or mounting device, as recited in claim 1, wherein said attach-and-release assembly or mounting device comprises one or more adaptors to fit in for different models or sizes of said camera, video recorder, or similar object.

7. An attach-and-release assembly or mounting device, as recited in claim 1, wherein said attach-and-release assembly or mounting device comprises one or more soft, compressible, or flexible materials, structures, components, or objects.

8. An attach-and-release assembly or mounting device, as recited in claim 1, wherein said attach-and-release assembly or mounting device comprises one or more soft, compressible, or flexible screw or thread structures or components.

9. An attach-and-release assembly or mounting device, as recited in claim 1, wherein said attach-and-release assembly or mounting device comprises one or more pivoting rigid arms.

10. An attach-and-release assembly or mounting device, as recited in claim 1, wherein said attach-and-release assembly or mounting device comprises one or more wedges.

11. An attach-and-release assembly or mounting device, as recited in claim 1, wherein said attach-and-release assembly or mounting device comprises one or more balloons or inflatable objects.

12. An attach-and-release assembly or mounting device, as recited in claim 1, wherein said attach-and-release assembly or mounting device comprises or is connected to one or more pumps, tanks, compressors, one-way valves, or pressure-relief valves.

13. An attach-and-release assembly or mounting device, as recited in claim 1, wherein said tripod or similarly attached device comprises one or more of the following: pivoting legs, hinged legs, flexible legs, rigid legs, goose-neck legs, segmented legs, snake-shaped flexible legs, telescopic legs, foldable legs with one or multiple folds or hinges per leg, hydraulic legs, mechanically-raising-legs, inflatable legs, balloon-type legs, tube-type legs, legs made of series of small beads, flat legs, cylindrical legs, legs with the suction cups at the end or bottom of the legs, curved legs, S-shaped legs, T-shaped legs, plate-shaped legs, sliding-plate-shaped legs, pairs of legs, multiple small legs, flexible small legs, horizontally-connected legs, independently-adjusted legs, or any conventional legs or supports.

14. An attach-and-release assembly or mounting device, as recited in claim 1, wherein said attach-and-release assembly or mounting device comprises of or is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band, net-shape material, mesh, hollow material, cushion material, solid object, magnetic material, metallic material, metallic sheet, metallic chain, array of metallic rings, 2-dimensional structure, multi-dimensional structure, flat structure, non-smooth plate, smooth plate, folded structure, hinged objects, hinged plates, hinged micro-plates, connected tiles, Lego-shaped material, brick-shaped material, ceramic tiles, stone tiles, artificial material tiles, glass tiles, transparent material, translucent material, clear material, reflective material, containing mirror, fluorescent material, metal-plated material, painted material, rug, woven material, bamboo, carpet material, wooden material, sticks, insulation material, water-cooling jacket, air-cooling jacket, heating-element jacket, insulation jacket, or any compound, chemical, or composite material.

15. An attach-and-release assembly or mounting device, as recited in claim 1, wherein said attach-and-release assembly or mounting device is connected to, or attached to, one or more of the following items: a picture frame, clock, notebook, calculator, solar cell array, battery, pen holder, pen, pencil, magnetic plate, magnetic decoration, magnetic pieces, Velcro, hook-and-loop, dual lock, fastener, rubber band, light, LED, LCD, display, TV, radio, thermometer, pressure gauge, biometric sensor, thumb or fingerprint recognition module, combination lock, lock, password entry input, keyboard, input device, pointing device, speaker, microphone, telephone set, keychain ring, hook, video game, music player, downloading unit, wireless unit, communication unit, antenna, small computer, small web browser, voice, video, picture recorder, vehicle, building, pole, external batteries, housings, flash assemblies, steady cam mounts, GPS devices, or any electronic or mechanical device, apparatus, system, toy, decoration, or equipment.

16. An attach-and-release assembly or mounting device, as recited in claim 1, wherein said attach-and-release assembly or mounting device comprises multiple layers.

17. An attach-and-release assembly or mounting device, as recited in claim 1, wherein said attach-and-release assembly or mounting device comprises or is connected to one or more sources of air, fluid, powder, gel, dust, sand, gas, liquid, pressurized gas, hot gas, foam, bubble material, or air bubble.

18. An attach-and-release assembly or mounting device, as recited in claim 1, wherein said camera, video recorder, or similar object is a surveying equipment, telescope, binocular, laser equipment, tracking or marking equipment, optical equipment, decoration item, store sign, product display, or level calibration equipment.

19. An attach-and-release assembly or mounting device, as recited in claim 1, wherein said attach-and-release assembly or mounting device is remotely controlled.

20. An attach-and-release assembly or mounting device, as recited in claim 1, wherein said attach-and-release assembly or mounting device is controlled by a computer, processor, or logic module, based on some rules or predetermined conditions.
